(19) United States
(12) Patent Application Publication
(10) Pub. No.: US 2021/0224214 A1
(43) Pub. Date: Jul. 22, 2021

(54) SYSTEM AND METHOD FOR IMPROVING SWITCHING EFFICIENCY OF DOUBLE NETWORK CARD NCSI MANAGEMENT SYSTEM

(71) Applicant: ZHENGZHOU YUNHAI INFORMATION TECHNOLOGY CO., LTD., Zhengzhou, Henan (CN)

(72) Inventors: Guoqiang ZHANG, Zhengzhou, Henan (CN); Weitao ZHAO, Zhengzhou, Henan (CN)

(73) Assignee: ZHENGZHOU YUNHAI INFORMATION TECHNOLOGY CO., LTD., Zhengzhou, Henan (CN)

(21) Appl. No.: 16/097,189

(22) PCT Filed: Jan. 5, 2018
(86) PCT No.: PCT/CN2018/071564

§ 371 Date: Oct. 26, 2018

(30) Foreign Application Priority Data
Aug. 4, 2017 (CN) 201710660887.0

(51) Int. Cl. G06F 13/40; G06F 11/07; G06F 11/30; G06F 1/30; G06F 1/26

(52) U.S. Cl. CPC G06F 13/4072; G06F 11/0796; G06F 2213/0026; G06F 1/30; G06F 1/263; G06F 11/3055

(57) ABSTRACT

A system for improving a switching efficiency of a double network card NCSI management system is provided. The system includes an NCSI Switch which is a two-to-one data strobe device. The NCSI Switch includes three groups of data links A, B, and C. The group A of NCSI data is linked to a controller with an NCSI function, i.e., a BMC MAC module. The group B of data is linked to an onboard network card end, and the group C of data is linked to an external network card slot. The NCSI Switch further includes a Select pin connected to an in-position detection pin of the external network card slot via a logic conversion circuit.

The present application claims the priority to the Chinese patent application No. 201710660887.0, titled “SYSTEM AND METHOD FOR IMPROVING SWITCHING EFFICIENCY OF DOUBLE NETWORK CARD NCSI MANAGEMENT SYSTEM”, and filed with the Chinese Patent Office on Aug. 4, 2017, which is incorporated by reference in its entirety herein.

### FIELD

The present application relates to the technical field of computer board card design, and in particular to a system and method for improving the switching efficiency of a double network card NCSI management system.

### BACKGROUND

A Sever, which is different from a general consumer electronic product, requires high reliability and stability. To this end, a complete server system is generally connected to BMC over a dedicated network, to monitor operation states of modules of a mainboard in real-time, such that the measures can be taken timely to ensure the normal operation of the system in the case of an abnormality of the system.

A BMC performs information interaction with the outside generally through the following two network methods: a dedicated management network and a shared management network.

For the dedicated management network, a complete management system is usually formed by an external PHY chip, an MAC module inside the BMC, a peripheral RJ45 connector and a server node switch and so on. For the shared management network, a network card controller is connected to a BMC MAC through the NCSI bus by means of the existing network card device, thereby indirectly achieving external access to the BMC and external information monitoring of a server mainboard system.

The two designs described above are usually adopted in the server. In contrast, the shared management network is favored by customers due to the use of a current device and generating no additional cost.

Furthermore, a double network card system, with an onboard network card and an external network card as a main data network, is a mainstream configuration of server products. The onboard network is used by default in the case that there is no external card, and an external card network is used in the case that an external card is inserted. NCSI management for BMC can be implemented by both network cards. However, the NCSI management system can only be accessed to one of the two networks at a certain time instant, and thus there is an actual requirement that an NCSI interface of the shared management network is switched between the onboard network card and the external network card.

Links of the NSCI management system are switched by generally adopting two methods in a traditional design of the server. In one method, the switching is controlled through an external physical switch. In the method, a control signal is controlled by an external switch (which is usually achieved by a contact pin matched with a jump cap). The control signal has a low level in the case that the external switch is connected to the ground, and the control signal has a high level in the case that the external switch is connected to a power supply. An NCSI switch is controlled to be connected to a link B (NCSI_0) or a link C (NCSI_1) under the two logic states.

In the other method, the switching is controlled by a BMC chip. In the method, a control signal is transmitted by the BMC chip. A same effect as the external switch is generated in the case that high and low level signals are respectively applied to the NCSI switch.

In the above technical solutions, an NSCI line has a low switching efficiency, because all of switching is artificially and initiatively triggered by means of external lines. In addition, in the actual shipping configuration, there is a great limitation.

First Solution

A signal control physical switch is usually located inside the mainboard, near a non-IO port. A chassis cover is required to be opened to operate a mainboard switch in the case that the NCSI line is switched. There is not only a risk of misoperation, but also implementation conditions for high-density server systems such as cabinet servers and blade servers are not met.

Second Solution

Personnel are required to initiatively trigger by software in BMC, which is difficult for non-professionals to operate. In the case that the NSCI is unavailable and the BMC cannot be accessed as well as the NCSI line is required to be switched through the BMC, the BMC is accessed over a dedicated management network, or it is needed to enter the OS so that the BMC is accessed using a dedicated tool, thereby switching the NCSI line.

### SUMMARY

In view of the problems above, the technical problem to be solved by the present application is to provide a system and method for improving a switching efficiency of a double network card NCSI management system, so as to improve the switching efficiency of the double network card NCSI management system.

The technical solutions provided in the present application are as follows.

A system for improving a switching efficiency of a double network card NCSI management system is provided, which includes an NCSI Switch. The NCSI Switch is a two-to-one data strobe device and includes three groups of data links A, B, and C. The group A of NCSI data is linked to a controller with an NCSI function, which is a BMC MAC module. The group B of data is linked to an onboard network card end, and the group C of data is linked to an external network card slot. The NCSI Switch further includes a Select pin connected to an in-position detection pin of the external network card slot via a logic conversion circuit.

The logic conversion circuit may be a MOS transistor, a triode or an NAND gate configured to perform level conversion, signal noise isolation or logical inversion.

A method for improving a switching efficiency of a double network card NCSI management system is provided. The method is applied to the above system and includes: selecting a link to be connected based on a signal of a logic conversion circuit through a Select pin of an NCSI Switch in such a manner that: an onboard network card is strobed in the case that the Select pin is in a low level, and an external network card is strobed in the case that the Select pin is in a high level.

The method may include: pulling low an in-position pin on the external network card slot while the external network card is inserted; forming a high level logic after converting performed via a logic inversion circuit, and transmitting the converted high level logic to the Select pin of the NCSI Switch; and connecting an NCSI bus of the link A with a link C of the external network card slot after the NCSI Switch receives the high level, and connecting the NCSI bus of the link A with the external network card via a BMC software layer, to indirectly achieve external access to a BMC and external information monitoring of a server mainboard system through a connection of a BMC MAC and the NCSI bus.

The present application has the following beneficial effects that: with the method of the present application, adaptive switching of the NCSI management system lines is realized, so that a traditional external artificial initiative triggering mode is not relied on no longer, thereby improving the switching efficiency. In terms of the project development, the software design difficulty is reduced and the manpower input is reduced; in terms of product operation and maintenance, a product fault tolerance rate is improved, an operation difficulty is reduced for the operation and maintenance personnel, thereby enhancing the product stability.

### BRIEF DESCRIPTION OF THE DRAWINGS

FIG. 1 is a schematic diagram of a switching solution of an NCSI management system according to the present application.

### DETAILED DESCRIPTION OF THE EMBODIMENTS

The present application is further described in conjunction with the detailed embodiments in accordance with the accompanying drawings.

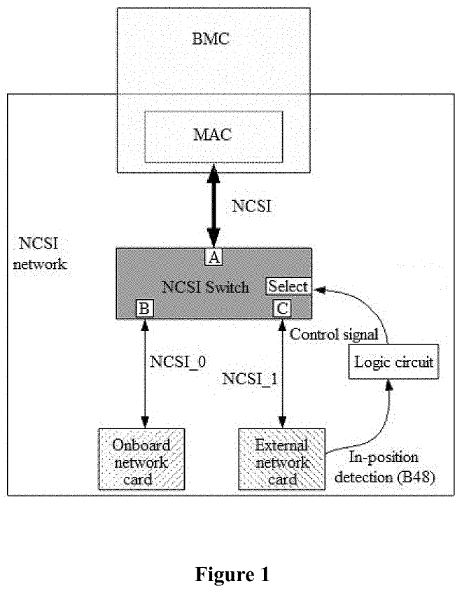

As shown in FIG. 1, in this embodiment, an external standard network card end is connected to a mainboard via a standard PCIe x8 golden finger, and a mainboard end is connected to the external standard network card end via a standard PCIe x8 Slot. A pin <B48> of the Slot is an in-position detection pin of a PCIe device. This pin is usually pulled up to a high level at the mainboard end, that is, logic “1”. The pin is automatically set to be a low level, that is, logic “0”, in the case that an external card is connected.

An NCSI switch is a two-to-one data strobe device. The NCSI switch includes a Select pin, in addition to three groups of data links AB/C, the necessary power supply and ground pins. The Group A of NCSI data is linked to a controller with an NCSI function, i.e., a BMC MAC module. The group B of data is linked to an onboard network card end, and the group C of data is linked to an external standard network card through a PCIe x8 slot and golden finger. The onboard network card is strobed in the case that the Select pin is in a low level, and an external network card is strobed in the case that the Select pin is in a high level.

The Select pin is connected to the in-position detection pin on the PCIe x8 slot. Logic strobed by the external network card on the switch is opposite to the logic transmitted on the Slot, and thus a logic conversion circuit needs to be added to the link. A PCIe in-position pin on the external network card slot is pulled low while the external network card is inserted. A high level logic is formed after converting performed via a logic inversion circuit and the converted high level logic is transmitted to the Select pin of the NCSI Switch. The link A is connected with a link C after the NCSI Switch receives the high level, and the NCSI bus of the A link is connected with the external network card via a BMC software layer.

In some scenarios, the working voltage on the slot is different from that on the switch, and a specific device is required to perform level conversion (for example, switching between 3.3V and 1.8V). In this embodiment, the level conversion is not involved in a logic circuit and the logic circuit can be implemented as a MOS transistor.

In this embodiment, TI TS3L501ERUAR is used for the NCSI switch, AST2500 from ASPEED Company is used for the BMC, and the MOS transistor used in the logic circuit is common N7002.

The embodiment is only used to illustrate the present application, and is not intended to limit the present application. Various changes and modifications may be made by an ordinary skilled person in the relevant art without departing from the spirit and scope of the present application. Thus, all equivalent technical solutions also fall within the scope of the present application, and the scope of patent protection of the present application is defined by the claims.

1. A system for improving a switching efficiency of a double network card NCSI management system, comprising an NCSI Switch, wherein
the NCSI Switch is a two-to-one data strobe device and comprises three groups of data links A, B, and C;
the group A of NCSI data is linked to a controller with an NCSI function, which is a BMC MAC module, the group B of data is linked to an onboard network card end, and the group C of data is linked to an external network card slot; and
the NCSI Switch further comprises a Select pin connected to an in-position detection pin of the external network card slot via a logic conversion circuit.

2. The system for improving the switching efficiency of the double network card NCSI management system according to claim 1, wherein the logic conversion circuit is a MOS transistor, a triode or an NAND gate configured to perform level conversion, signal noise isolation or logical inversion.

3. A method for improving a switching efficiency of a double network card NCSI management system, applied to a system for improving a switching efficiency of a double network card NCSI management system, wherein the system comprises an NCSI Switch, the NCSI Switch is a two-to-one data strobe device, and comprises three groups of data links A, B, and C and a Select pin connected to an in-position detection pin of the external network card slot via a logic conversion circuit, and the method comprises:
selecting a link to be connected based on a signal of the logic conversion circuit through a Select pin of the NCSI Switch in such a manner that:
an onboard network card is strobed in the case that the Select pin is in a low level, and an external network card is strobed in the case that the Select pin is in a high level.

4. The method for improving the switching efficiency of the double network card NCSI management system according to claim 3, comprising:
pulling low an in-position pin on the external network card slot while the external network card is inserted;
forming a high level logic after converting performed via a logic inversion circuit, and transmitting the converted high level logic to the Select pin of the NCSI Switch; and
connecting an NCSI bus of the link A with a link C of the external network card slot after the NCSI Switch receives the high level, connecting the NCSI bus of the link A with the external network card via a BMC software layer, to indirectly achieve external access to a BMC and external information monitoring of a server mainboard system through a connection of a BMC MAC with the NCSI bus.

5. The method for improving the switching efficiency of the double network card NCSI management system according to claim 3, wherein the logic conversion circuit is a MOS transistor, a triode or an NAND gate configured to perform level conversion, signal noise isolation or logical inversion.
